(19) United States
(12) Patent Application Publication
(10) Pub. No.: US 2020/0086848 A1
(43) Pub. Date: Mar. 19, 2020

(54) DRIVE TRAIN AND MOTOR VEHICLE

(71) Applicant: Schaeffler Technologies AG & Co. KG, Herzogenaurach (DE)

(72) Inventors: Yang Zhou, Ettlingen (DE); Martin Vornehm, Bühl (DE)

(73) Assignee: Schaeffler Technologies AG & Co. KG, Herzogenaurach (DE)

(21) Appl. No.: 16/470,703

(22) PCT Filed: Dec. 8, 2017
(86) PCT No.: PCT/DE2017/101052

§ 371 Date: Jun. 18, 2019

(30) Foreign Application Priority Data
Dec. 19, 2016 (DE) 10 2016 124 828.2

(51) Int. Cl. B60W 20/40; B60K 6/365; B60K 6/383; B60K 6/24; B60K 6/26; B60W 30/19; B60W 10/06; B60W 10/08; F16H 1/28

(52) U.S. Cl. CPC B60W 20/40; B60K 6/365; B60K 6/383; B60K 6/24; B60K 2006/381; B60W 30/19; B60W 10/06; B60W 10/08; F16H 1/28; B60K 6/26

(57) ABSTRACT

A drive train for a vehicle comprises an input shaft, an output shaft, a first planetary gearing unit, a second planetary gearing unit and a third planetary gearing unit, each having a sun wheel, a carrier wheel and an annulus. The carrier wheel of the first planetary gearing unit is coupled to the sun wheel of the second planetary gearing unit. The annulus of the first planetary gearing unit is coupled to the carrier wheel of the second planetary gearing unit and to the annulus of the third planetary gearing unit. The annulus of the second planetary gearing unit is coupled to the carrier wheel of the third planetary gearing unit. The drive train has a first clutch device and a second clutch device, wherein the first and second clutch devices are connected by input sides thereof to the input shaft. The drive train has a first braking device, a second braking device and a third braking device. The drive train further includes an electric machine having an output coupled to the sun wheel of the first planetary gearing unit and to the first braking device.

### CROSS-REFERENCE TO RELATED APPLICATIONS

This application is the U.S. National Phase of PCT Appln. No. PCT/DE2017/101052 filed Dec. 8, 2017, which claims priority to DE 102016124828.2 filed Dec. 19, 2016, the entire disclosures of which are incorporated by reference herein.

### TECHNICAL FIELD

The present disclosure relates to a drive train for a vehicle, in particular for a passenger car, and to the vehicle itself.

### BACKGROUND

As part of the process of enabling vehicles to be driven electrically, there is an increasing requirement for hybrid modules, by means of which the electric traction drive can be combined with the operation of an internal combustion engine.

Currently available hybrid modules, which can combine electric motor operation with operation by an internal combustion engine by coupling an internal combustion engine to a drive train of a vehicle, generally comprise an electric motor, a separating clutch, the actuating system thereof and bearings and housing components, which connect the three main components to form a functional unit. The electric motor allows electric driving, power in addition to that provided by operation of the internal combustion engine, and energy recovery. The separating clutch and the actuating system thereof ensure the coupling and decoupling of the internal combustion engine.

A vehicle with a hybrid module, e.g. with a P2 hybrid module, offers more driving states than a conventional vehicle with an internal combustion engine or a pure electric vehicle. However, there is also a need for a significantly larger number of parts to be provided with different means of rotatable support and to be coupled to and decoupled from each other.

DE 10 2009 038 344 A1 discloses a drive train module for a motor vehicle which comprises a hybrid module, in which a subclutch is arranged within the space occupied by the electric machine of the hybrid module.

DE 10 2015 007 439 B3 teaches a hybrid drive train with multispeed automatic transmission, which is based on a 9-speed automatic transmission. In this hybrid drive train, the electric machine is coupled to a carrier shaft of the first planetary gear assembly.

Another known transmission with a large number of speeds is the Chrysler 68RFE illustrated in FIG. 1.

The gears which can be selected in this transmission can be seen from the following overview:

| Gear | Transmission ratio | K1 | K2 | K3 | B2 | B1 | B3 |
|---|---|---|---|---|---|---|---|
| 1 | 3.23 | X | | | | | X |
| 2 | 1.83 | X | | | X | | |
| 3 | 1.41 | X | | | | X | |
| 4 | 1.00 | X | X | | | | |
| 5 | 0.81 | | X | | | X | |
| 6 | 0.62 | | X | | X | | |
| Rev | −4.44 | | | X | | | X |

The individual abbreviations have the following meanings:
K1: first clutch device
K2: second clutch device
K3: third clutch device
B1: first braking device
B2: second braking device
B3: third braking device
1-6: gears 1-6
Rev: reverse gear

By combining the actuation of the six selector elements, six forward gears with a spread of 5.2 and one reverse gear can be implemented. In gear changes, just one element has to be selected and one disengaged in all cases.

The individual devices must be designed for different torque capacities relative to the torque applied to the transmission input:

B3: at least 546%, wherein the design-relevant gear is the reverse gear,

K3: at least 100%, wherein the design-relevant gear is the reverse gear,

K1: at least 100%, wherein the design-relevant gear is the first gear, the second gear or the third gear,

K2: at least 100%, wherein the design-relevant gear is the fifth gear or the sixth gear,

B2: at least 84.2%, wherein the design-relevant gear is the second gear,

B1: at least 40.9%, wherein the design-relevant gear is the third gear.

For safety reasons, the stated torque capacity should have an additional dynamic reserve and accordingly should be increased by 10%, for example.

The design-relevant gear is the gear in the transmission which makes the most severe demands on the torque capacity of the clutches or brakes and is thus the dominant gear in terms of requirements.

A known technical solution is to combine an internal combustion engine and an electric motor, as a result of which the sum of the two maximum torques gives the design-relevant torque applied to the transmission input (in the absence of a control limitation).

Also known are “P2 hybrid modules”, in which the electric machine is situated functionally and geometrically at the transmission input.

In order to achieve a maximum of additional electric functionality, a separating clutch, referred to as a “K0”, is often used between the internal combustion engine and the electric machine in this case. There are many variants in the embodiment of this separating clutch: from positive dog clutches to freewheels, synchronized selector clutches and dry friction clutches or clutches running in oil. The structural integration of this clutch is also known, e.g. within the electric motor, axially directly adjacent to a clutch leading to the transmission input or in combination with hydrodynamic torque converters. It is likewise known that, although the electric machine is connected to the transmission input, it is connected with a fixed transmission ratio, e.g. via a belt drive (axially parallel) or a toothed chain (axially parallel) or a spur gear stage (axially parallel) or a dedicated planetary gear set (coaxial).

Known hybrid transmissions with an electric machine integrated into the transmission often have only a small number of speeds (e.g. three to five), wherein the speeds are implemented in many different ways in terms of mechanical engineering: from spur gearings and synchronized shifts to planetary sets with clutches or brakes involving many different technologies and continuously variable friction drives. The fuel saving that is achieved in other transmissions by a suitable selection of transmission ratios can also be achieved in these transmissions in a different way, namely through the hybrid function and load point shifting and electric driving, thus enabling the number of speeds to be kept small.

Likewise known are multispeed automatic transmissions with up to ten speeds, wherein in these transmissions combination with a P2 hybrid head is obvious, inter alia because integration of the electric machine results in very complex operating modes. In the case of multispeed transmissions which are designed for the combined use of an internal combustion engine and an electric machine, referred to as P2 hybrid modules, however, there is the design restriction that there is a large installation space requirement for transmission components of the large number of speeds, and therefore there remains only very limited installation space that can be used for an electric machine of adequate size.

### SUMMARY

It is therefore the underlying object of the present disclosure to make available a drive train for a motor vehicle which, while requiring little installation space, combines high driving comfort with low energy consumption.

The present disclosure relates to a drive train for a vehicle, in particular for a passenger car, having an input shaft, an output shaft, a first planetary gearing unit, a second planetary gearing unit and a third planetary gearing unit, each having a sun wheel, a carrier wheel and an annulus.

The carrier wheel of the first planetary gearing unit is coupled or can be coupled in a rotationally fixed manner to the sun wheel of the second planetary gearing unit, the annulus of the first planetary gearing unit is coupled or can be coupled in a rotationally fixed manner to the carrier wheel of the second planetary gearing unit and to the annulus of the third planetary gearing unit, and the annulus of the second planetary gearing unit is coupled or can be coupled in a rotationally fixed manner to the carrier wheel of the third planetary gearing unit. Furthermore, the drive train has a first clutch device and a second clutch device, wherein the clutch devices are connected by the input sides thereof to the input shaft, and the output side of the first clutch device is coupled or can be coupled in a rotationally fixed manner to the sun wheel of the third planetary gearing unit, and the output side of the second clutch device is coupled or can be coupled in a rotationally fixed manner to the carrier wheel of the second planetary gearing unit. Moreover, the drive train has a first braking device, a second braking device and a third braking device, wherein the first braking device is coupled or can be coupled in a rotationally fixed manner to the sun wheel of the first planetary gearing unit, the second braking device is coupled or can be coupled in a rotationally fixed manner to the carrier wheel of the first planetary gearing unit, the third braking device is coupled or can be coupled in a rotationally fixed manner to the annulus of the first planetary gearing unit, to the carrier wheel of the second planetary gearing unit, to the annulus of the third planetary gearing unit, and the output shaft is coupled or can be coupled in a rotationally fixed manner to the carrier wheel of the third planetary gearing unit. The drive train furthermore comprises an electric machine, in particular an electric motor, the output of which, preferably in the form of a rotor, is coupled or can be coupled in a rotationally fixed manner to the sun wheel of the first planetary gearing unit and to the first braking device.

The carrier wheel should also be taken to mean the unit comprising the planet wheels.

By means of a respective braking device, the rotation of the wheel connected thereto can at least be braked, preferably locked, in relation to a frame or housing.

It is preferable if the carrier wheel of the second planetary gearing unit is coupled or can be coupled in a rotationally fixed manner to the annulus of the third planetary gearing unit.

Provision is furthermore advantageously made for the “stationary ratio” (the transmission ratio between the sun wheel and the annulus when the planet carrier is stationary) of the first planetary gearing unit to be −1.5 to −1.8, that of the second planetary gearing unit to be −1.5 to −1.8 and that of the third planetary gearing unit to be −2 to −2.5.

That is to say that the electric machine is positioned in a manner such that the output of the electric machine is connected to the torque path between the output of the third clutch device and the first braking device in such a way that the rotary motion of the electric machine can be transmitted to the sun wheel of the first planetary gearing unit and, via clutch devices, to the other two planetary gearing units.

In the sense according to the present disclosure, the rotationally fixed coupling or ability for rotationally fixed coupling which is mentioned should be taken to mean that the respective first assembly mentioned in respect of coupling is mechanically connected to the second assembly mentioned in respect of coupling without the interposition of another assembly mentioned in this context. If appropriate, this connection can be implemented directly by means of a suitable torque transmission member.

To be specific, therefore, the electric machine in the six-speed Chrysler 68RFE transmission is logically connected downstream of an existing clutch and is thus no longer arranged at the transmission input. The embodiment according to the present disclosure makes it possible to dispense with the arrangement of an extra separating clutch.

In one embodiment of the drive train, said drive train has a third clutch device, which is likewise connected by the input side thereof to the input shaft, wherein the output side of the third clutch device is coupled or can be coupled in a rotationally fixed manner to the sun wheel of the first planetary gearing unit, the first braking device is coupled or can be coupled in a rotationally fixed manner to the output side of the third clutch device, and the output of the electric motor is coupled or can be coupled to the output side of the third clutch device.

By means of this optional embodiment of the drive train, driving movements at low speeds can be implemented by selecting the internal combustion unit.

However, the drive train according to the present disclosure is not restricted to the use of the third clutch device but can also be embodied without the third clutch device. With or without the third clutch device, the drive train can be used to implement an “E gear”, which allows electric driving at low speeds, both forwards and in reverse.

This means that, combined with the integration of the electric machine, it is possible to dispense with the third clutch device since reversing can be achieved exclusively in the electric driving mode by means of the E gear.

Here, the drive train according to the present disclosure can be embodied in such a way that the operation of the third clutch device is based on positive engagement.

Examples of embodiments based on positive engagement are switchable freewheels, having, for example, rollers, pawls, wedging disks, screw cone elements or even dog clutches, if appropriate in combination with friction synchronization. These embodiments are more economical in respect of costs, installation space and drag losses.

The electric machine and the first braking device can furthermore be arranged directly adjacent to one another structurally or spatially.

The drive train preferably comprises an internal combustion engine with an internal combustion engine torque capacity, wherein the electric torque capacity of the electric machine is at least 40% of the internal combustion engine torque capacity.

As an alternative or in addition, the drive train can be embodied in such a way it comprises an internal combustion engine with an internal combustion engine torque capacity, and the second clutch device is designed to transmit at least 150% of the internal combustion engine torque capacity, in particular more than 250% of the internal combustion engine torque capacity.

More than 250% of the internal combustion torque capacity is necessary if a constant output torque is to be applied to the output shaft. This means that the second clutch device can transmit at least 150% of the maximum torque provided by the internal combustion engine. If a constant output torque is required at the output shaft, a torque of as much as 250% of the maximum torque provided by the internal combustion engine is transmitted by the second clutch device at full power. The second clutch device should be configured in a corresponding manner.

The first clutch device can furthermore be designed to transmit at least 140% of the internal combustion engine torque capacity.

In another embodiment, it is envisaged that the second braking device is designed to absorb at least 250% of the internal combustion engine torque capacity.

That is to say that the second braking device is designed and configured in such a way that it can hold at least 250% of the maximum torque provided by the internal combustion engine at the full load of the drive train.

The operation of a braking device can be based on one or more of the following principles of action:
switchable freewheel, in particular roller freewheel or wedging-element freewheel,
self-energizing mechanism, in particular wedge brake, band brake or strap,
positive engagement, in particular claw brake,
blocking synchronization.

That is to say that, combined with the integration of the electric machine, modification, even of the first braking device, with a view to more compact, less variable power transmission technology, different embodiments are possible, e.g. in the form of a switchable freewheel, e.g. with rollers, pawls, wedging disks, screw cone elements; or as a static friction clutch, which has static friction elements with a high coefficient of friction, e.g. ceramic pads, hard fiber linings, hook and loop bands; or in the form of a clutch with a self-energizing mechanism, which can have friction elements with a self-energizing effect, e.g. a band brake, wrap spring, boost ramps; or in the form of a clutch or brake based on positive engagement, which can be embodied, for example, as a dog clutch, if appropriate in combination with friction synchronization.

Although the third braking device requires a high torque capacity in the E gear and also in first gear, it is used only in these gears.

Insofar as suitable measures are taken when gear changing between first gear and second gear or certain torque fluctuations are acceptable, the third braking device can be embodied in a positive-locking way and consequently can be integrated in a very compact design. Moreover, the third braking device can also be embodied as a combined device which combines braking elements acting on the basis of positive engagement with a freewheel or frictionally acting elements.

Here too, once again, different assemblies can be employed, e.g. switchable freewheels with rollers, pawls, wedging disks or screw cone elements, or devices based on positive engagement, e.g. a dog clutch, if appropriate in combination with friction synchronization.

Integrating the electric machine at the optimum installation location according to the present disclosure makes it possible to employ clutch elements which are smaller or have smaller dimensions or to dispense with additional clutch elements or those which are necessary in the absence of an electric machine. Moreover, the installation location according to the present disclosure allows structural combination by virtue of spatial proximity to brakes.

Shift processes can be electrically synchronized, thus enabling some conventional shift elements to be converted from friction technology (multiplate clutches, synchronizer rings) to positive-locking technology with a smaller installation space requirement. As a result, these shift elements require significantly less installation space, which can be made available for the integration of a suitable electric machine.

To complete the present disclosure, a motor vehicle is made available which has at least one driven wheel, which can be driven by means of a drive train according to the present disclosure.

### BRIEF DESCRIPTION OF THE DRAWINGS

The present disclosure described above is explained in detail below in relation to the relevant technical background, with reference to the associated drawings, which show preferred embodiments. The present disclosure is not in any way restricted by the purely schematic drawings, and it should be noted that the illustrative embodiments shown in the drawings are not restricted to the dimensions illustrated.

FIG. 1: shows a conventional drive train illustrating the geometric positions of the individual devices,

FIG. 2: shows a drive train according to the present disclosure illustrating the logical positions of the individual devices,

FIG. 3: shows a drive train according to the present disclosure illustrating the geometric positions of the individual devices,

FIG. 4: shows a diagram intended to illustrate the torque loading of the first braking device B1,

FIG. 5: shows a diagram intended to illustrate the torque loading of the second braking device B2,

FIG. 6: shows a diagram intended to illustrate the torque loading of the first clutch device K1,

FIG. 7: shows a diagram intended to illustrate the torque loading of the second clutch device K2,

FIG. 8: shows a diagram intended to illustrate the torque loading of the third braking device B3,

FIG. 9: shows a diagram intended to illustrate the torque loading of the third clutch device K3,

FIG. 10: shows a diagram intended to illustrate a control method for carrying out the gear change from 2 to 3,

FIG. 11: shows a diagram intended to illustrate a control method for carrying out driving away using the electric machine.

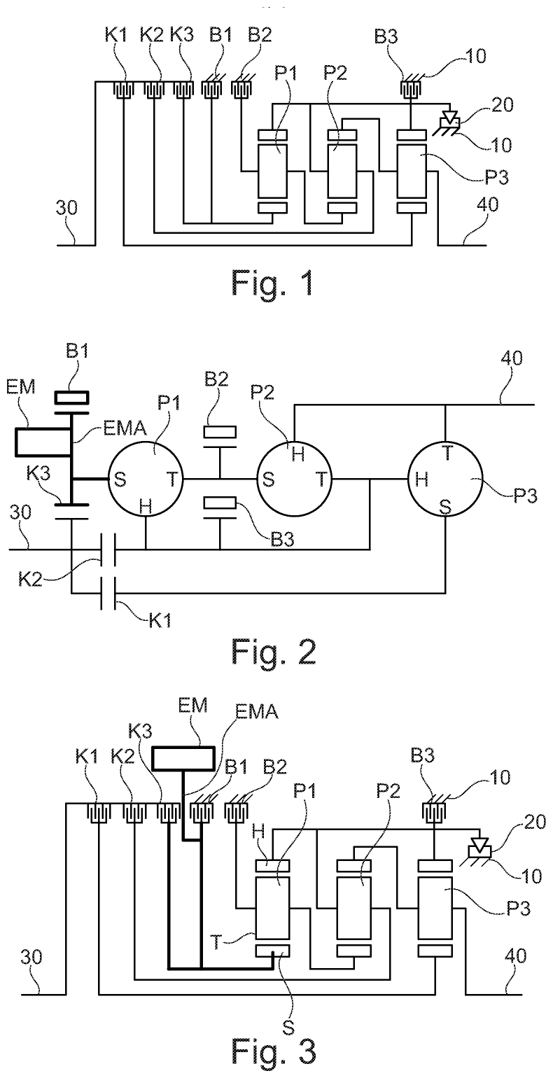

### DETAILED DESCRIPTION

The logical configuration of the drive train in accordance with the present disclosure is illustrated in FIG. 2.

The electric machine EM is arranged logically downstream of the third clutch device K3 and in parallel with the first braking device B1 and the sun wheel S of the first planetary gearing unit P1.

Corresponding to the logical position is a structural association with a geometric location, this being illustrated by way of example in FIG. 3.

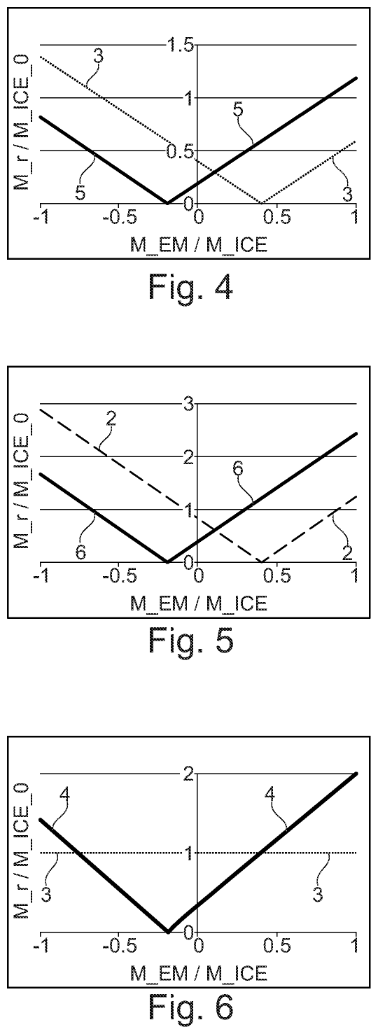

Here, the installation position is between the third clutch device K3 and the first braking device B1. In this case, however, the present disclosure is not restricted to this geometric location of the electric machine EM; on the contrary, the electric machine EM could also be arranged in a functionally equivalent way between the first braking device B1 and the second braking device B2. The arrangement of the electric machine in direct proximity to the brake B1 is structurally advantageous because owing to its large mass and the applied magnetic forces, the rotor requires good support, the bearing support frame of which is also capable of supporting the nonrotating side of a brake B1. In the drive train according to the present disclosure, individual devices must be designed in accordance with the dependencies illustrated for each device in FIGS. 4-9, wherein a torque reserve should preferably be included in addition in each case.

FIGS. 4-9 illustrate the respective loading M_r of a device by a torque as a function of the maximum torque of the internal combustion engine M_ICE and that of the electric motor M_EM.

It can be seen here in the case of each device that the degree of hybridization, which is plotted on the X axis, has a major effect on which gear requires the maximum torque of the respective device, wherein the torque value which acts on the respective device in the respective gear and accordingly is relevant to design is plotted on the Y axis.

In other words, FIGS. 4-9 illustrate how the respective torque M_r acting on the device is as a function of the total torque composed of the individual torques of the internal combustion engine and the electric machine, depending on the gear implemented.

FIG. 4 shows this for gears 3 and 5, wherein the function M_r=|(0.18M_ICE+M_EM)| applies to gear 3 and the function M_r=|(−0.41M_ICE+M_EM)| applies to gear 5.

FIG. 5 shows this for gears 2 and 6, wherein the function M_r=|(−0.84M_ICE+2.06M_EM)| applies to gear 2 and the function M_r=|(0.38 M_ICE+2.06M_EM)| applies to gear 6.

FIG. 6 shows this for gears 3 and 4, wherein the function

M_r=|(M_ICE)| applies to gear 3, and the function M_r=|(0.31M_ICE+1.69M_EM)| applies to gear 4.

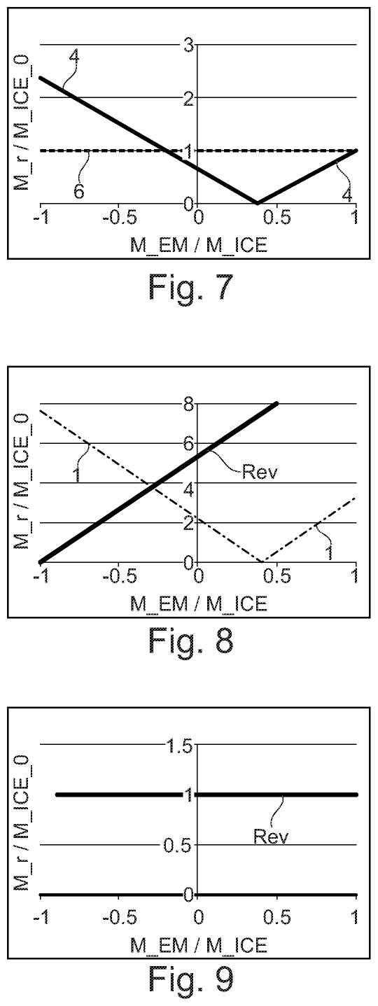

FIG. 7 shows this for gears 4 and 6, wherein the function

M_r=|(0.69M_ICE+1.69M_EM)| applies to gear 4, and the function M_r=|(M_ICE)| applies to gear 6.

FIG. 8 shows this for gears 1 and Rev (reverse gear) wherein the function

M_r=|(−2.23M_ICE+5.46M_EM)| applies to gear 1, and the function M_r=|(5.46M_ICE+5.46M_EM)| applies to reverse gear.

FIG. 9 shows this for reverse gear, wherein the function M_r=|(M_ICE)| applies.

From FIG. 4, it can be seen that the first braking device B1 can be made more compact and/or can be designed for a lower power than conventional embodiments since it is substantially load-free at 40% of the torque M_EM provided by the electric machine in relation to the torque of the internal combustion engine M_ICE. Thus, the first braking device B1 can, for example, be fitted with a switchable freewheel 20, optionally with rollers, pawls, wedging disks, screw cone elements, or with static friction elements with a high coefficient of friction, e.g. ceramic pads, hard fiber linings, hook and loop bands, or with friction elements with a self-energizing effect, e.g. band brakes, wrap springs, boost ramps; or can be of positive-locking configuration, e.g. in the form of a dog clutch, if appropriate in combination with friction synchronization. In this case, the first braking device B1 should be designed for 30-60% of the maximum torque that can be provided by the internal combustion engine, in particular to 40-50% of this maximum torque.

The same applies to the third clutch device K3, which can be seen in FIG. 9.

It can furthermore be seen from FIG. 4, that the torque capacity of the electric machine is advantageously approximately at least 40% of the torque capacity of the internal combustion engine.

From FIG. 5, it can be seen that the torque capacity of the second braking device B2 should advantageously be designed for about 250% of the maximum torque provided by the internal combustion engine.

From FIG. 6, it can be seen that the first clutch device K1 should advantageously be designed for at least 140% of the maximum torque provided by the internal combustion engine.

From FIG. 7, it can be seen that the torque capacity of the second clutch device K2 should advantageously be around at least 150% of the maximum torque provided by the internal combustion engine. Detailed analysis subject to the boundary condition of a constant output torque shows that as much as about 250% of the maximum torque provided by the internal combustion engine is required for the second clutch device K2.

The following shift diagram can be obtained by means of the drive train according to the present disclosure illustrated in FIGS. 2 and 3.

| Gear | K1 | K2 | K3 | B2 | B1 | B3 | M_Out/M_ICE | M_Out/M_EM | M_ICE/M_EM |
|---|---|---|---|---|---|---|---|---|---|
| 1 | X | | | | | X | 3.23 | −4.46 | |
| 2 | X | | | X | | | 1.84 | −1.06 | |
| 3 | X | | | | X | | 1.41 | | |
| CVT1 | X | | | | | | 1.41 | 3.45 | −2.45 |
| 4 | X | X | | | | | 1.00 | 1.00 | |
| 5 | | X | | | X | | 0.82 | | |
| CVT2 | | X | | | | | 0.82 | −4.45 | 5.45 |
| 6 | | X | | X | | | 0.62 | −1.06 | |
| Rev | | | X | | | X | −4.46 | −4.46 | |
| E1 | | | | | | X | | −4.46 | |
| E2 | | | | X | | | | 1.06 | |
| L | | | X | | | | | | 1.00 |

Here, M_Out is the output torque of the drive train.

M_EM is the torque provided by the electric machine. M_ICE is the torque provided by the internal combustion engine.

Of relevance here are, on the one hand, the advantageous additional operating modes CVT 1, CVT 2, E1, E2 and L added by virtue of the arrangement of the electric machine EM and, on the other hand, the additional mode transitions resulting therefrom. These additional mode transitions make it possible to ensure comfort, even without frictional shift elements, since less friction energy arises in the clutch devices K1, K2, K3 and, at the same time, a constant torque at the outlet is ensured.

The CVT1 mode, in which the first clutch device K1 is closed and the rotor of the electric machine EM rotates, can be used to improve comfort and/or reduce frictional losses and/or synchronize rotational speeds in all gear changes between gears 1, 2, 3 and 4.

Another option for the use of the CVT1 mode is to allow a “charging driveaway” when the battery is empty but the internal combustion engine is running while the vehicle is stationary. In this context, the internal combustion engine turns the electric machine EM with a negative rotational speed, thus enabling the electric machine EM to charge the battery while operating as a generator. At the same time, the power flow from the internal combustion engine to the electric machine EM produces a transmission output torque, which can be used to drive away the vehicle.

The CVT2 mode, in which the second clutch device K2 is closed, can be used to improve comfort and/or reduce frictional losses and/or, where applicable, for complete rotational speed synchronization in all gear changes between gears 4, 5 and 6.

Moreover, the CVT2 mode allows continuously variable or stepped-ratio driving with rotational speed ratios beyond sixth gear and thus forms a widening of the spread of the transmission similar to an additional “gear 7”.

The E1 mode allows forward and reverse electric driving at low speeds.

The E2 mode allows purely electric forward driving or “coasting” with a relatively low amount of tractive effort (relatively small electric transmission), e.g. at relatively high road speeds.

Thanks to this new hybrid function, it is possible in one particular embodiment of the drive train to dispense with the third clutch device K3 when the reverse gear is implemented by means of the E1 mode.

While driving in the E1 mode, the internal combustion engine can be started at any time, either by using a separate starter motor, e.g. as a belt drive machine, or by engaging the first clutch device K1 to implement gear 1 with corresponding simultaneous activation, for the purpose of increasing the torque, of the electric machine EM assigned to the transmission, thus ensuring that the output torque of the transmission remains as far as possible constant in order to enhance comfort. Furthermore, the E mode can also be used for purely electric reversing, particularly when there is not supposed to be a third clutch device K3.

The charging mode L can be used when the vehicle is stationary, if appropriate when the brakes are actuated, or when traveling slowly for the purpose of coupling the battery to the internal combustion engine, with the output otherwise decoupled, i.e. with the vehicle being capable of rolling.

This mode is also suitable for “coasting” when driving in gear 4. The speed of the internal combustion engine when charging or coasting is a matter of free choice and can be the idling speed or, alternatively, higher, i.e. closer to the rotational speed at which gear 4 is reengaged, this having advantages as regards acoustics and driving dynamics.

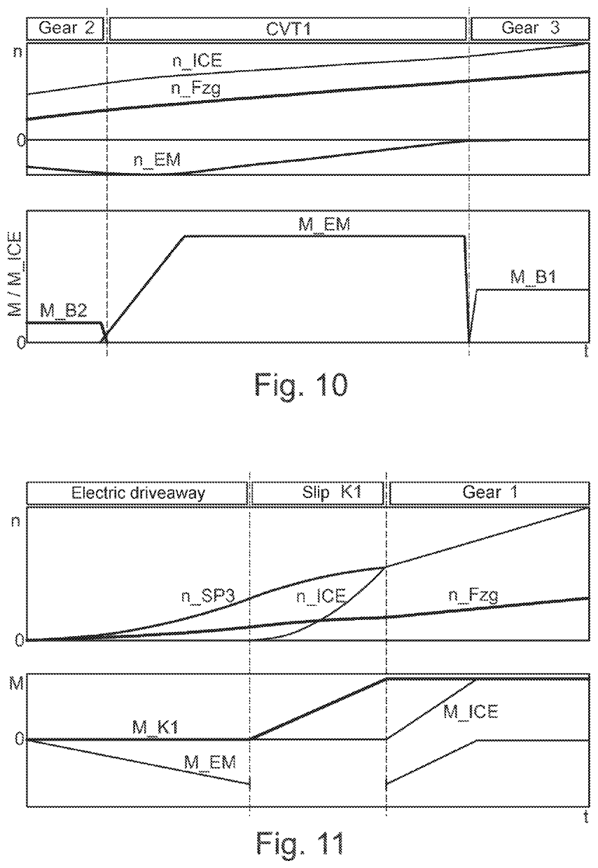

FIG. 10 illustrates a control method, showing how the gear change from 2 to 3 is carried out using the electric machine EM, thus enabling the first braking device B1 to be actuated in a positive-locking manner but nevertheless comfortably. The control method can also be used with a frictional braking device B1 and then reduces the frictional losses.

It can be seen here that, when operating in gear 2, a certain torque is present at the second braking device B2. For the purpose of changing gear, this is reduced, and the torque of the electric machine M_EM is raised, this corresponding to the CVT1 mode. After the brake B2 is opened, the initially negative rotational speed n EM of the electric machine EM is reduced toward 0 by corresponding operation (braking) of the electric machine. This means that the torque is produced by the electric machine EM, allowing gear 3 to be engaged, namely by closing or engaging the first braking device B1, which can be designed in a corresponding manner to be positive-locking. As a result, the rotational speed n_Fzg of the entire drive train rises in a comfortable manner during this sequence of operations.

FIG. 11 illustrates a control method, showing how driveaway is carried out using the electric machine EM, wherein the third braking device B3 is actuated, and how the change to gear 1 takes place (under power from the internal combustion engine).

First of all, the amount of torque from the electric machine M_EM is increased in response to driver demand, e.g. through actuation of a pedal, in order to drive the vehicle away.

The effect of this is the rise in the rotational speed n_Fzg of the entire drive train. Depending on the state of charge of the battery or road speed or, alternatively, a driver demand, the use of the internal combustion engine can be initiated.

A friction torque is built up at the first clutch device K1 in order to crank the internal combustion engine. The effect of this is a rise in the rotational speed of the internal combustion engine n_ICE and, once the internal combustion engine has started, there is likewise a rise in the torque M_ICE made available by the internal combustion engine. When the rotational speed of the internal combustion engine n_ICE and the rotational speed of the sun wheel S of the third planetary gearing unit P3 are uniform, the clutch device K1 can be fully engaged. Depending on the state of charge of the battery and, if appropriate, driver demand when accelerating the vehicle and consequently increasing the rotational speed of the drive train n_Fzg in gear 1, the torque M_ICE made available by the internal combustion engine can be increased and the torque M_EM made available by the electric motor can be reduced.

As an alternative to cranking with the aid of the clutch device K1, there is the possibility of starting the internal combustion engine by means of a belt or pinion starter. This enables synchronization by the first clutch device K1 to take place at a low differential rotational speed.

Development, modification and even simplification of the drive train described with an integrated electric machine EM is conceivable in many respects.

The third clutch device K3 can be of positive-locking design or can even be omitted completely. In this case of complete omission of the third clutch device K3, the operating modes “Rev” (reverse gear) and “L” (charging mode) are eliminated. The elimination of the operating mode “Rev” is compensated for by the operating mode “E1”, in which the electric machine EM allows reversing by means of reverse rotation. The elimination of the operating mode “L” can be compensated, for example, by a battery of correspondingly large dimensions or by means of a charging function of a generator or of a belt-type starter generator.

Another refinement is to make the third braking device B3 of positive-locking design. It requires a high torque capacity in the E1 mode and also in gear 1. Since it is only required in these gears, a very much more compact positive-locking design can be implemented.

It is likewise possible to employ a combined construction which unites a freewheel 20 with a positive-locking principle of operation or which unites a freewheel 20 with a frictional principle of operation.

With the present disclosure proposed here, it is thus possible to make available a drive train having electric or hybrid driving functions which, by virtue of the logical position of the electric machine EM within the transmission, makes it possible to dimension individual devices of the drive train in accordance with the respective torque requirements made upon it and thus to reduce the installation space for these devices and consequently for the entire drive train.

### LIST OF REFERENCE SIGNS

P1 first planetary gearing unit
P2 second planetary gearing unit
P3 third planetary gearing unit
S sun wheel
T carrier wheel
H annulus
K1 first clutch device
K2 second clutch device
K3 third clutch device
B1 first braking device
B2 second braking device
B3 third braking device
EM electric machine
EMA output (of the electric machine)
M_r loading of a device by a torque
M_ICE torque of the internal combustion engine
M_EM torque of the electric machine
1 first gear
2 second gear
3 third gear
4 fourth gear
5 fifth gear
6 sixth gear
Rev reverse gear
10 frame
20 freewheel
30 input shaft
40 output shaft

1. A drive train for a vehicle, comprising: an input shaft, an output shaft a first planetary gearing unit, a second planetary gearing unit and a third planetary gearing unit, each having a sun wheel, a carrier wheel and an annulus, wherein:
the carrier wheel of the first planetary gearing unit is coupled in a rotationally fixed manner to the sun wheel of the second planetary gearing unit,
the annulus of the first planetary gearing unit is coupled in a rotationally fixed manner to the carrier wheel of the second planetary gearing unit and to the annulus of the third planetary gearing unit,
the annulus of the second planetary gearing unit is coupled or can be coupled in a rotationally fixed manner to the carrier wheel of the third planetary gearing unit, and the drive train has a first clutch device and a second clutch device, wherein the first and second clutch devices are connected by input sides thereof to the input shaft, and
an output side of the first clutch device is coupled in a rotationally fixed manner to the sun wheel of the third planetary gearing unit,
an output side of the second clutch device is coupled in a rotationally fixed manner to the carrier wheel of the second planetary gearing unit, and the drive train has a first braking device, a second braking device and a third braking device, wherein
the first braking device is coupled in a rotationally fixed manner to the sun wheel of the first planetary gearing unit,
the second braking device is coupled in a rotationally fixed manner to the carrier wheel of the first planetary gearing unit,
the third braking device is coupled in a rotationally fixed manner to the annulus of the first planetary gearing unit, to the carrier wheel of the second planetary gearing unit, to the annulus of the third planetary gearing unit, and wherein the output shaft is coupled in a rotationally fixed manner to the carrier wheel of the third planetary gearing unit, and
an electric machine having an output coupled in a rotationally fixed manner to the sun wheel of the first planetary gearing unit and to the first braking device.

2. The drive train as claimed in claim 1, further comprising: a third clutch device connected by an input side thereof to the input shaft, wherein:
an output side of the third clutch device is coupled in a rotationally fixed manner to the sun wheel of the first planetary gearing unit,
the first braking device is coupled in a rotationally fixed manner to the output side of the third clutch device, and
the output of the electric machine is coupled to the output side of the third clutch device.

3. The drive train as claimed in claim 2, wherein operation of the third clutch device is based on positive engagement.

4. The drive train as claimed in claim 1, wherein the electric machine and the first braking device are arranged structurally directly adjacent to one another.

5. The drive train as claimed in claim 1, further comprising: an internal combustion engine with an internal combustion engine torque capacity, and wherein an electric torque capacity of the electric machine is at least 40% of the internal combustion engine torque capacity.

6. The drive train as claimed in claim 1, further comprising: an internal combustion engine with an internal combustion engine torque capacity, and the second clutch device is configured to transmit at least 150% of the internal combustion engine torque capacity.

7. The drive train as claimed in claim 1, further comprising: an internal combustion engine with an internal combustion engine torque capacity, and the first clutch device is configured to transmit at least 140% of the internal combustion engine torque capacity.

8. The drive train as claimed in claim 1, further comprising: an internal combustion engine with an internal combustion engine torque capacity, and the second braking device is configured to absorb at least 250% of the internal combustion engine torque capacity.

9. The drive train as claimed in claim 1, wherein operation of the first, second, or third braking device is based on one or more of the following principles of action:
switchable freewheel,
self-energizing mechanism,
positive engagement, and
blocking synchronization.

10. A motor vehicle having at least one driven wheel, which can be driven by a drive train as claimed in claim 1.

11. The drive train as claimed in claim 1, wherein the electric machine is an electric motor.

12. The drive train as claimed in claim 1, further comprising: an internal combustion engine with an internal combustion engine torque capacity, and the second clutch device is configured to transmit more than 250% of the internal combustion engine torque capacity.
